(19) United States
(12) Patent Application Publication
(10) Pub. No.: US 2004/0135932 A1
(43) Pub. Date: Jul. 15, 2004

(54) User-changeable video monitor face plate

(76) Inventor: Hung Ching Kuen, Chai Wan (HK)

Correspondence Address: VEDDER PRICE KAUFMAN & KAMMHOLZ, 222 N. LASALLE STREET, CHICAGO, IL, 60601, US

(21) Appl. No.: 10/339,531

(22) Filed: Jan. 9, 2003

(51) Int. Cl. G02F 1/1333; H02B 1/00

(52) U.S. Cl. 349/58; 361/600

(57) ABSTRACT

A removable escutcheon for a video monitor (10) such as a television receiver or computer display is provided by a removable face plate (16) that is sized and shaped to fit over the front side 12 of the monitor (10). The face plate (16) has an aperture (22) through which a video display device such as a CRT, LCD or plasma screen can be viewed. Face plate attachment posts (24, 26, 28 and 30) are sized and shaped to extend into and engage corresponding face plate mounting holes (32) formed in the front of the monitor (10).

### BACKGROUND OF THE INVENTION

Video monitors, such as television receivers and computer monitors are well known in the art. They include a display device such as a cathode ray tube (CRT), a liquid crystal display (LCD) or a plasma display device, on which images can be produced and viewed. At present, the video display device is mounted into a housing that includes a front face or escutcheon through which various controls are accessible and on which markings are applied. The front face or escutcheon also serves to provide an aesthetic appearance around the video display device.

Unfortunately, prior art video monitors provide no capability by which the front face' aesthetic appearance can be changed. Once a video monitor is designed and then manufactured, the aesthetic appearance cannot be altered by a user. A mechanism by which the appearance of a video monitor could be changed by a user would be an improvement over the prior art.

### BRIEF DESCRIPTION OF THE DRAWINGS

FIG. 1 shows a front view of a video monitor, such as a television receiver or a computer display having a removable escutcheon.

FIG. 2 shows a perspective view of a monitor with the removable escutcheon removed, showing the front side and a monitor on which images are produced.

FIG. 3 shows an exploded view of the monitor including the removable escutcheon.

FIG. 4 shows a face plate for use as a removable escutcheon.

FIG. 5 shows the face plate, and its inner surface and, an aperture through which a monitor of the television can be viewed and additional apertures through which controls are accessible.

FIG. 6 shows the face plate in cross section through two attachment posts and shows a portion of the front face of the monitor.

FIG. 7 shows an alternate embodiment of the face plate.

FIG. 8 shows an alternate embodiment of the face plate.

FIG. 9 shows a cooling fan on the video monitor.

### DETAILED DESCRIPTION OF THE PREFERRED EMBODIMENTS

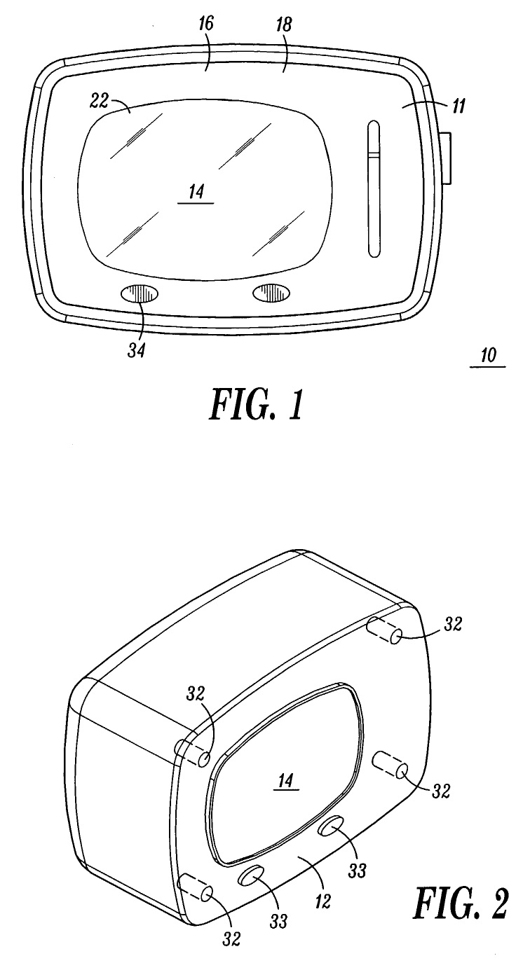

FIG. 1 shows a video monitor 10, embodied as a television receiver, a monitor for a closed circuit security camera, a computer monitor for use with a computer, or a video game terminal. The video monitor 10 includes a video display device 14, such as a CRT, LCD or plasma display on which video images can be viewed using techniques well-known to those of ordinary skill in the art of video processing. For purposes of claim construction, a video image is any text or graphic for viewing by a user.

The monitor 10 is provided with a removable escutcheon 11, preferably formed of a molded plastic and to which one or more distinguishing colors can be applied or which can be colored. The escutcheon is removably attached to a front side 12 (not shown in FIG. 1) of the video monitor 10 using one or more attachment posts, described more fully below, which project into and frictionally engage corresponding face plate mounting holes in the front side 12 of the monitor 10, and which is behind the removable escutcheon 11. For purposes of claim construction, the escutcheon/face plate is considered to be “removably attached” in that it can be readily removed after assembly without damaging the monitor so as to permit replacement by another escutcheon/face plate. Removal of the escutcheon/face plate is facilitated by the various mechanisms described herein, which include the attachment posts, hook and loop fasteners such as VELCRO®, adhesive tape or a latch at either the top and/or bottom of the escutcheon, the functions of all of which are to attach the face plate to the front 12 of the monitor such that it can be removed without damaging the monitor.

The escutcheon 11, which is comprised of the face plate 16, has a first aperture 22, which the face or screen of the display device 14, is viewable from a position in front of the monitor 10. The escutcheon 11 face plate 16 outer surface 18 can be distinctively colored to either contrast with or match any color that may be applied to other exterior surfaces of the monitor 10.

FIG. 2 shows a prospective view of the monitor 10 of FIG. 1, albeit with the face plate 16 removed to reveal the front side 12 of the monitor 10. As can be seen in FIG. 2, the monitor 10 front side 12 has formed therein, several attachment post mounting holes 32. The attachment post mounting holes 32 are located, sized and shaped to receive face plate attachment posts that are attached to the inner surface of the face plate 16 (but which are not shown in FIG. 1 or FIG. 2).

FIG. 2 also shows the placement of control knobs 33, which are commonly used on video monitors for such functions as speaker volume, channel selection, contrast and picture intensity and the like. The control knobs 33, are considered to be “controls” in that they control the operation of the video display device 14 and/or the monitor 10.

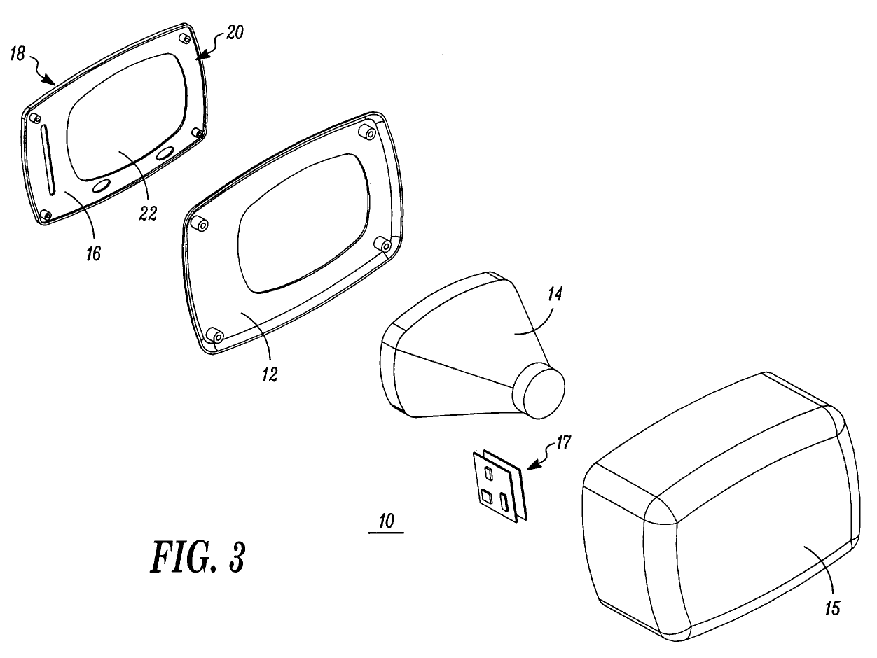

FIG. 3 shows an exploded view of some of the components of an exemplary monitor 10. A video display device 14 is shown in FIG. 3 to be a CRT. Alternate and equivalent embodiments of a monitor would employ LCDs and plasma displays.

The monitor 10 of shown in FIG. 3 has a front side 12, formed as a front cabinet portion that is attached to the rear of the cabinet 15. As shown in FIG. 2, a removable face plate 16 is applied or attached to the front 12 by way of mounting holes 32 (not shown in FIG. 3) formed in the front side 12 so as to provide an orifice into which a mounting post on the face plate can be inserted to frictionally or mechanically engage front 12 of the monitor 10 by the removable face plate 16.

In a preferred embodiment, the cabinet 15 is perforated above the CRT 14 and provided with a fan 60, the orientation of which is adjustable such that in a lowered position, the fan can move air through the interior of the cabinet 15 via the aforementioned perforation. In a raised position, the fan can move air toward, or away from a person positioned in front of the monitor 10.

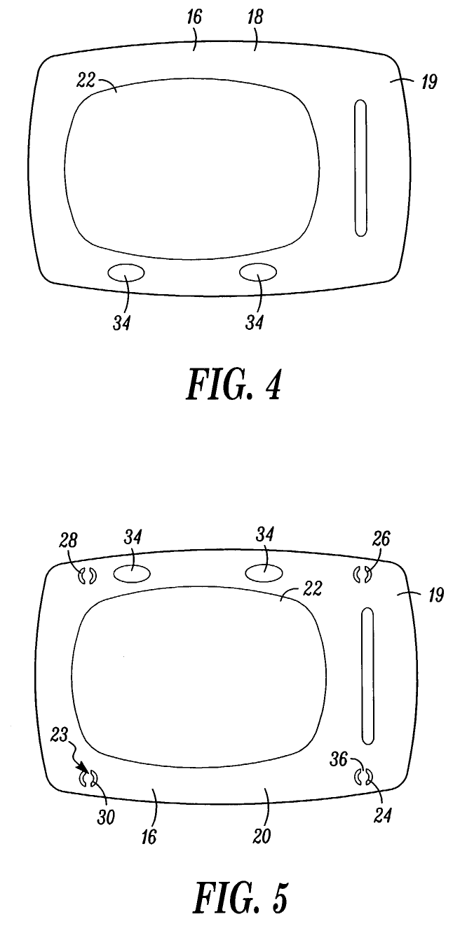

FIG. 4 shows a front view of a removable face plate 16 for a monitor. As can be seen in FIG. 4, the face plate 16 has an outer surface 16 to which colorant (e.g., paint) can be applied or which can be dyed or tinted. Markings, trademarks or legends can be also be applied to the face plate 16.

The face plate 16 has a first aperture 22, sized to accommodate a video display device 14 on which video images can be made to appear. The aperture 22 enables the video display device 14 (not shown in FIG. 4) to viewed by a monitor user. As shown in FIG. 4, the removable face plate 16 also has one or more other apertures 34 by which a control device, such as a volume control or channel selector for the monitor 10 can be operated when the face plate 16 is physically attached to the monitor 10.

FIG. 5 shows the inner surface 20 of the removable face plate 16 shown in FIG. 5. In particular, FIG. 5 shows a top view of four, face plate 16 attachment posts 24, 26, 28 and 30, in part by which the face plate 16 can be removably attached to the front side of a monitor. The face plate attachment posts 24, 26, 28 and 30 are formed by being molded as part of the face plate 16.

As is well-known to those of ordinary skill in the CRT art, many CRTs are manufactured with a slightly convex face. In order to provide a snug fit between the face plate 16 and the video display device, the inner surface 20 of the face plate 16 is preferably formed to be slightly concave, i.e., to include a slight curvature to substantially conform to and mate with the front side 12 of the monitor 10 and the front of the video display device 14.

In a preferred embodiment, and as shown in FIG. 5, the face plate attachment posts are formed to have slots 23 that run at least part way through the length of the posts. The posts are formed to project substantially orthogonally away from the inner surface 20 of the face plate 16 so that they can extend into the face plate mounting holes 32 in the front face 12 of the monitor 10. The slots 23 in the attachment posts enable the slotted portions of the attachment posts to deflect or bend as the attachment post is inserted into a slightly undersized face plate mounting hole 32. The slight deformation of the mounting posts that is enabled by the slots 23 improves the frictional engagement of the mounting post 30 to a face plate mounting hole 32.

For purposes of claim construction, the attachment posts are “substantially orthogonally” in that whether the attachment posts are round cross-sections, square cross-sections or other geometric shapes, they extend away from the inner surface 20 of the face plate 16 such that they will extend into a complementary-shaped face plate mounting hole 30. In FIG. 2, the face plate mounting holes 30 are shown as being round although they could be other geometric shapes.

Each of the attachment posts 24, 26, 28 and 30 are sized and shaped to extend into the aforementioned face place mounting holes 32, which are preferably molded into the front side 12 of the monitor 10, so as to mechanically engage the mounting posts 24, 26, 28 and 30 and keep the face plate 16 attached to the front side or face 12 of the monitor 10. When the mounting posts 24, 26, 28 and 30 are aligned with and inserted into the face plate mounting holes 32, the holes 32 and posts 24, 26, 28 and 30 are both sized and shaped such that a frictional or interference fit is created between the posts 24, 26, 28 and 30 and the holes 32. The face plate is considered to be “removably attached” because the face plate 16 can be removed and replaced upon the exertion of an extraction force upon the fact plate 16.

It can be seen in FIG. 5, that each of the attachment posts has an upper, or distal end 36 that is furthest from the inner surface 20 of the face plate 16. In a preferred embodiment shown in FIG. 5, the attachment posts 24, 26, 28 and 30 are molded to form a cylinder having with an inner diameter D and a length L. Each of the cylindrically-shaped attachment posts has an opening at the distal end 36, which in an alternate embodiment can accept a complimentary locking post, which can be formed in the front side 12 of the monitor so as to extend from the front face of the monitor, into the mounting posts 24, 26, 28 and 30.

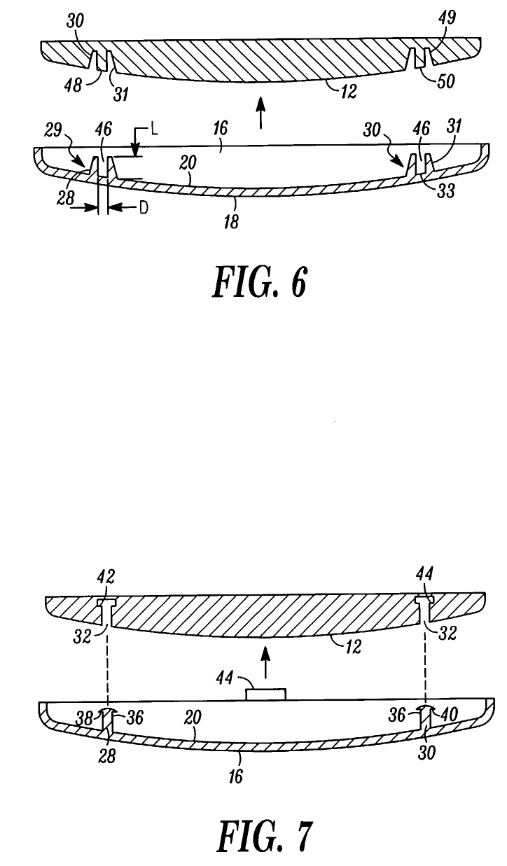

FIG. 6 shows the removable escutcheon face plate 16 in cross section, through two of the attachment posts 28 and 30 depicted in FIG. 5. As can be seen in FIG. 6, the attachment posts 28 and 30 extend substantially orthogonally from the inner surface 20 of the face plate 16, which is curved to conform to and mate with the front side 12 of a monitor to which the removable escutcheon would be attached. As is also shown in FIG. 5 and FIG. 6, the face plate 16 and the front of the monitor 12 have a curvature. The curvature of the face plate 16 inner surface 18 will substantially conform to the curvature of the video display device 14 used in the monitor 10 in order for the face plate 16 to fig snugly on the front 12 of the monitor 10. In embodiments wherein the video display device is a CRT, there will usually be some curvature associated with the face of the CRT, although some CRTs do indeed have substantially flat surfaces. In such a case, the inner surface 18 of the face plate 16 is preferably flat as well.

The first attachment post 28 is formed to be substantially cylindrical, the bottom or lower end of which is molded as part of the face plate 16. The top or upper end of the first attachment post 28 is open, exposing the inner regions of the cylinder with an inner diameter D, and a height or extent L. The outer surface 29 of the mounting post 28 frictionally or mechanically engages the inner surface 31 of the face plate mounting hole 30 so to attach the face plate 16 to the front side 12. In such a preferred embodiment, the outside diameter of the mounting post 28 should be slightly greater than the inside diameter of the face plate mounting hole. When the attachment post and mounting hole are formed from a plastic material, it will deform upon insertion of the post into the hole forming a mechanical coupling.

In a preferred embodiment, the face plate attachment posts and the face plate mounting holes are of circular cross section. Alternate and equivalent embodiments would include rectangular or elliptical cross sections.

In an alternate embodiment, the attachment post 28 can be formed to accept either a tapered or a non-tapered, complimentary locking post 48 that is formed into the interior of the face plate mounting hole 30. When a locking post 48 is provided, it should extend from the bottom of the face plate mounting hole 30, into the diameter D of the attachment post 28. In such an embodiment, the locking post 48 serves to more precisely align the face plate 16 and at least frictionally engage the inner surfaces of the cylindrical shaped mounting posts inner diameter D.

An alternate embodiment of a locking post and attachment post can be seen in the right-hand side of FIG. 6. A second mounting post 30 is shaped to be tapered along its outside 31 and cylindrically shaped on its inside 33 so as to provide an interference fit with a cylindrically-shaped face plate mounting hole 49 in the front face 12 of the monitor 10.

The second embodiment shown in FIG. 6 has a tapered inner locking post 50. Upon the insertion of the tapered attachment post 30 into the face plate mounting hole 49 with the tapered locking post 50, that a frictional or interference fit between the tapered face 31 and the cylindrically shaped hole 49 will exist. Similarly, the tapered blocking post 50 engages the cylindrical interior 33 of the attachment post 30.

FIG. 7 shows another alternate embodiment of the attachment posts of the face plate 16. In FIG. 7, the face plate 16 is provided with attachment posts 28 and 30 that have at their distal ends 36, locking tabs 38 and 40. The attachment posts 28 and 30 are sized such that when the face plate 16 is applied to the front face 12 of the monitor 10, the attachment posts 28 and 30 extend through the mating face plate mounting holes 32 such that the locking tabs 38 and 40, mate with ridges 42 and 44 at the extent of the mounting holes 32 so as to removably attach the face plate 16 to the front surface 12 of the monitor 10.

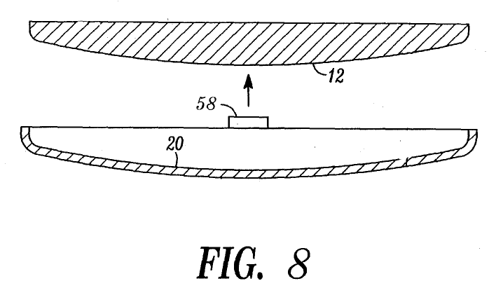

In addition to the attachment posts and the corresponding holes 30, FIG. 8 shows yet another embodiment of a structure, the function of which is to removably attach the face plate 16. In FIG. 8, a locking tab 58 is formed on either the top or bottom edges of the face plate 16, or on both the top and bottom edges or side edges of the face plate 16. The locking tab 58 is sized and shaped so as to lockingly engage a complementary recess formed the front face 12 of the monitor 10 but not readily shown in figures. Molded locking tabs and complementary recesses or latching ridges are known in the art as mechanisms by which assemblies can be held together.

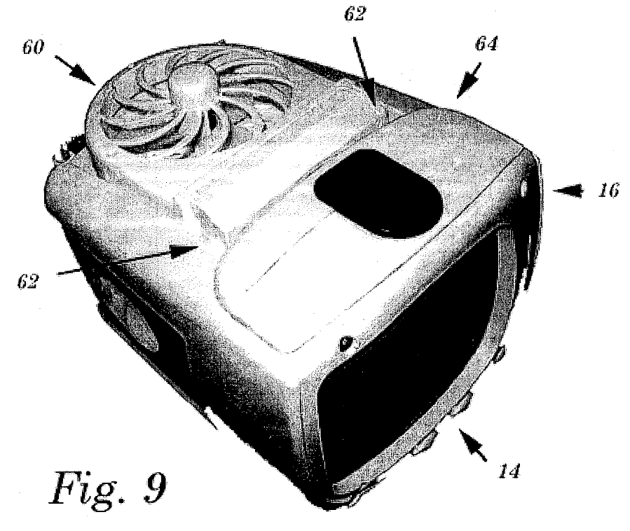

FIG. 9 shows yet another embodiment of the video monitor 10, which includes a cooling 60 fan in a pivotally mounted by hinges 62 to the video monitor housing 64. As shown in FIG. 9, the fan 60 can be operated to force air downward and into the housing 64 through perforations in the housing 64 (obscured in FIG. 9 by the fan 60) thereby cooling a CRT-equipped monitor 10. In a second, upright position (not shown in FIG. 9) the fan housing (and hence the fan motor and fan) is rotated about an axis 66 using a hinge 62 so that air can be directed toward, or away from, the front of the video monitor.

It should be appreciated that a video monitor or television receiver 10 can be provided with a removable escutcheon, which can be colorized to distinguish the monitor or receiver simply by way of the removable escutcheon. As set forth above, the removable escutcheon is comprised of the aforementioned face plate having a first aperture, which is sized and shaped to conform to the video display device. The face plate is removably attached to the front side of the video monitor by the various structures disclosed above (the attachment posts, tapered and non-tapered, with and without slots, with and without a locking tab or tabs), the functions of which are to removably attach the face plate to the front side of the video monitor. Alternate and equivalent structures for performing the function of removably attaching the face plate to the video monitor would include, but are not limited to so-called hook and loop fasteners (not shown for clarity), single or double-sided adhesive or adhesive tape, both of which can also be applied to the inner surface 20 of the mounting plate 16 or to the front side 12 of the monitor 10.

By providing a removable escutcheon for a video monitor, such as a monitor, the overall appearance of the monitor or video monitor can be readily changed by a user simply by removing one face plate of one color, and attaching a second face plate of a different or complementary color. Manufacturing costs can be reduced yet provide different color schemes to a monitor or video monitor.

What is claimed is:

1. A removable escutcheon for a video monitor, said video monitor having a front side and a video display device viewable from said front side on which images are produced, said escutcheon comprising:
a face plate, having an outer surface and having an inner surface that is shaped to substantially conform to, and mate with, the front side, said face plate having:
a first aperture through which said video display device can be viewed;
a plurality of face plate attachment posts, each of said attachment posts projecting substantially orthogonally from the inner surface of said face plate, each of said attachment posts being sized and shaped to extend into a corresponding face plate mounting hole formed in the front of the video monitor receiver so as to engage the mounting hole to removably attach the face plate to the video monitor.

2. The removable escutcheon of claim 1 further comprising:
at least a second aperture in said face plate by which a control device for said video monitor is operable when said face plate is attached to said video monitor.

3. The removable escutcheon of claim 1 wherein said attachment posts frictionally engage a face plate mounting hole.

4. The removable escutcheon of claim 1 wherein an attachment post has a distal end at which there is a locking tab to engage the face plate when said attachment post is inserted into a corresponding mounting hole.

5. The removable escutcheon of claim 1 further including at least one locking tab on said face plate to engage said front of said video monitor.

6. The removable escutcheon of claim 1 further including a hook and loop fastener attached to the inner surface of said face plate and a complementary hook and loop fastener attached to the front side of said video monitor by which said removable escutcheon is held in place on said front.

7. The removable escutcheon of claim 1 wherein said front side of said monitor is non-planar and said inner surface of said face plate is shaped to substantially conform to said non-planar front side of said monitor.

8. The removable escutcheon of claim 1 wherein at least one of said attachment posts are substantially cylindrical, with a slot formed therein, said slot extending from the distal end of the attachment post at least part way down the post toward the inner surface of said face plate.

9. The removable escutcheon of claim 1 wherein at least one of said attachment posts are substantially cylindrical, said substantially cylindrical attachment post having an inner diameter D and a length L and being open at the distal end so as to accept through the opening at the distal end, a locking post that extends from the front face of the monitor and which frictionally engages with the inner surfaces of said substantially cylindrical attachment post.

10. The removable escutcheon of claim 1 wherein said locking post has a length by which it extends from the front surface of said monitor and is tapered along at least part of it's length.

11. The removable escutcheon of claim 1 wherein said face plate has a first distinctive color.

12. The removable escutcheon of claim 11 wherein said video monitor has a second distinctive color.

13. A removable escutcheon for a monitor, said monitor having a front side and a video display device, viewable from said front side and on which images are produced, said escutcheon comprising:
a face plate, having an outer surface and having an inner surface that is shaped to substantially conform to, and mate with, the front side, said face plate having:
a first aperture through which said video display device can be viewed from said front side;
a face plate attachment means for removably attaching said face plate to said monitor front side.

14. The removable escutcheon of claim 13 wherein said face plate attachment means is comprised of: a plurality of face plate attachment posts, each of said attachment posts projecting substantially orthogonally from the inner surface of said face plate, each of said attachment posts being sized and tapered to extend into a corresponding face plate mounting hole formed in the front of the monitor so as to engage the mounting hole to removably attach the face plate to the monitor.

15. A monitor, said monitor comprised of:
a front side;
a video display device on which images are produced and viewable from said front side;
a removable front escutcheon comprising:
a face plate, having an outer surface and having an inner surface that is shaped to substantially conform to, and mate with, the front side, said face plate having:
a first aperture through which images on said video display device can be viewed;
a face plate attachment means for removably attaching said face plate to said front side.

16. The monitor of claim 15 wherein said face plate attachment means is comprised of:
a plurality of face plate attachment posts, each of said attachment posts projecting substantially orthogonally from the inner surface of said face plate, each of said attachment posts being sized and shaped to extend into a corresponding face plate mounting hole formed in the front of the monitor so as to engage the mounting hole to removably attach the face plate to the monitor.

17. The monitor of claim 15 wherein said face plate attachment means is comprised of a locking tab formed into said face plate and which lockingly engages the front side of said monitor.

18. The monitor of claim 15 wherein said face plate attachment means is comprised of a hook and loop fastener.

19. The monitor of claim 15 wherein said face plate attachment means is comprised of an adhesive.

20. The monitor of claim 15 further comprising:
at least a second aperture in said face plate by which a control device for said monitor is operable when said face plate is attached to said monitor.

21. The removable escutcheon of claim 16 wherein said attachment posts frictionally engage a face plate mounting hole.

22. The removable escutcheon of claim 16 wherein an attachment post has a distal end at which there is a locking tab to engage the face plate when said attachment post is inserted into a corresponding mounting hole.

23. The removable escutcheon of claim 16 further including at least one locking tab on said face plate to engage said front.

24. The removable escutcheon of claim 16 wherein at least one of said attachment posts are substantially cylindrical, with a slot formed therein, said slot extending from the distal end of the attachment post at least part way down the post toward the inner surface of said face plate.

25. The removable escutcheon of claim 16 wherein at least one of said attachment posts are substantially cylindrical, said substantially cylindrical attachment post having an inner diameter D and a length L and being open at the distal end so as to accept through the opening at the distal end, a locking post that extends from the front face of the monitor and which frictionally engages with the inner surfaces of said substantially cylindrical attachment post.

26. The removable escutcheon of claim 16 wherein said locking post has a length by which it extends from the front surface of said monitor and is tapered along at least part of it's length.
